(19) United States
(12) Patent Application Publication
(10) Pub. No.: US 2006/0173385 A1
(43) Pub. Date: Aug. 3, 2006

(54) Ultrasound probe having a central opening

(76) Inventors: Lars Lidgren, Lund (SE); Kaj Larsson, Lund (SE)

Correspondence Address: LADAS & PARRY LLP, 224 SOUTH MICHIGAN AVENUE, SUITE 1600, CHICAGO, IL, 60604, US

(21) Appl. No.: 10/557,326

(22) PCT Filed: Jun. 4, 2004
(86) PCT No.: PCT/SE04/00863

§ 371 Date: Nov. 21, 2005

(30) Foreign Application Priority Data
Jun. 4, 2003 (SE) 0301624-3

(51) Int. Cl. A61H 1/02

(52) U.S. Cl. 601/2; 600/439

(57) ABSTRACT

The invention relates to an ultrasound probe having a central opening (22) in an arrangement for ultrasound treatment of a patient. The probe has a front portion adapted to be placed at, against or in an object to be treated and is arranged to emit an ultrasound field having an intensity maximum located in the object for heating thereof. The central opening (22) improves the emitted intensity pattern and enables irrigation of the transmitter.

### FIELD OF THE INVENTION

The present invention relates to an ultrasound probe having a central opening formed by one or more holes in an arrangement for ultrasound treatment of a patient The probe has a front portion adapted to be placed at, against or in an object to be treated and is arranged to emit an ultrasound field having an intensity maximum located in the object for heating thereof. The central openings improve the emitted intensity pattern and enables irrigation of the transmitter.

### STATE OF THE ART

Heating a tissue in patients for therapeutic purposes by means of ultrasound is previously known. Commonly, phased array transducers having multiple crystals co-operating to emit an ultrasound field have been used. The multiple transmitters are controlled to achieve the acquired focusing. Phased array transducers require complex and expensive electronics, in addition to the costs of the phased array transducers itself.

Also transducers having single or a few transmitter elements have been used. These transducers have a fixed focus achieved by shaping the crystals or focusing the ultrasound field by means of additional devices.

The emitted ultrasound field has an intensity pattern with a maximum located in the object to be treated. An exemplifying pattern is shown in FIG. 6A. Besides the desired maximum peak M, there is another peak P, albeit with lower intensity, in the near ultrasound field. In addition to being located outside the object to be treated and thus being a waste of power, it causes an unnecessary heating. In case the object to be treated is superficial, such as a tendon or ligament, this near peak may be located in the patient's skin and cause pain.

### SUMMARY OF THE INVENTION

An object of the present invention is to provide an ultrasound probe, which reduces the effect of unwanted peaks in the near ultrasound field.

In a first aspect, the invention provides an ultrasound probe comprising a probe body and a transducer means for generating a focussed ultrasound field, the intensity maximum of which is located in an object for heating thereof.

According to the invention, the transducer means has a central opening adapted to reduce the effect of unwanted peaks in the near ultrasound field, formed by one ore more holes.

In a second aspect, the invention provides a use of an ultrasound probe as defined above.

The invention is defined in the attached claims 1 and 20, while preferred embodiments are set forth in the dependent claims.

### BRIEF DESCRIPTION OF THE DRAWINGS

The invention will be further described below with reference to the accompanying drawings, in which

FIG. 1 schematically shows a use of the device according to the invention;

FIG. 2 is a detailed view in cross-section of a probe according to the invention;

FIG. 3 is a front view of the probe in FIG. 2;

FIG. 4 is a side view of the transducer and connected tube;

FIG. 5 is a front view of the transducer with connected tube; and

FIGS. 6A and 6B are schematic diagrams of ultrasound field intensity versus distance from the transmitter without a centre opening and with a centre opening according to the invention, respectively.

### DETAILED DESCRIPTION OF PREFERRED EMBODIMENTS

The invention will be described below in relation to a method for thermotherapy, particularly mini-invasive ultrasound treatment of intervertebral discs. The invention is also applicable in non-invasive treatment such as tendons and ligaments and the invention is not limited to any particular application.

Methods for thermotherapy and coagulation of tissue involve use of focused ultrasound with high intensity. The ultrasound passes well through soft tissue and can be focused on remote spots within a volume of a few cubic millimetres. The energy absorption in the tissue increases the temperature with a sharp temperature gradient such that the boundaries of the treated volume are clearly limited without causing any damages on the surrounding tissue.

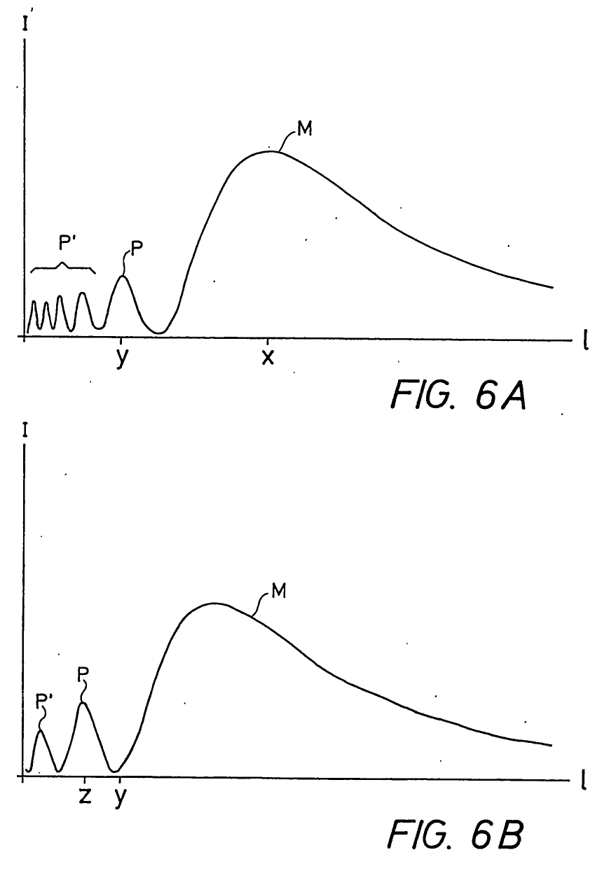

In mini-invasive ultrasound treatment, the therapeutic ultrasound transducer is inserted through a small cut in the skin of the patient and moved towards the object to be treated. In non-invasive ultrasound treatment the therapeutic ultrasound transducer is applied against the skin of the patient's tissues, such as tendons and ligaments in for example shoulders, knees, elbows or feet In both mini-invasive and non-invasive treatment, the intensity peak (P in FIG. 6A) in the near ultrasound field is undesirable.

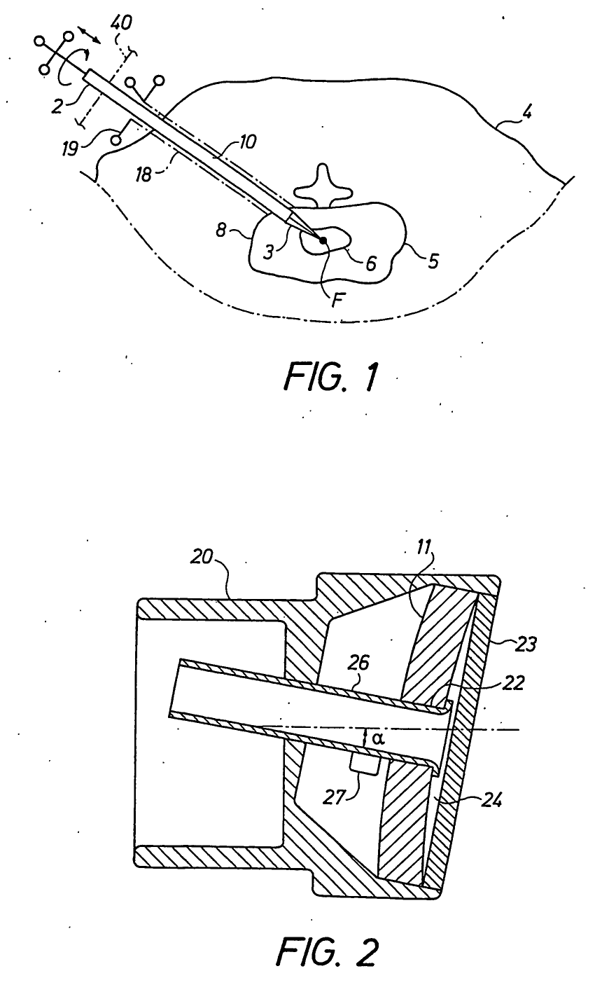

The treatment device 1 schematically illustrated in FIG. 1 is intended for producing, by means of at least one therapeutic ultrasound transducer 2 (so called therapeutic transducer), an ultrasound field 3, the intensity maximum F of which is intended to be located in an object 5 of the patient 4 for treatment thereof. The object can for example be the nucleus pulposus 6 in an intervertebral disc 5 of the patient 4, but it can also be another object such as a ligament or tendon in e.g. a shoulder, knee, elbow or a foot However, in the description text below reference will be made to the treatment of a disc.

The therapeutic ultrasound transducer 2 is in this example intended to be inserted through the patient's 4 skin, e.g. by means of a cut or by means of an introducer, such as a cannula 18, and contact the disc 5, preferably annulus fibrosus 8, to achieve a local temperature increase in the disc 5, which results in shrinking of the disc 5. A heating to for example 60-70 degrees Celsius can directly achieve collagen shrinkage. The therapeutic ultrasound transducer 2 can be placed against the disc 5 without perforating the annulus fibrosus 8 and from there transmit the ultrasound field 3 focused with its intensity maximum F in the treatment volume.

The treatment device 1 can comprise a rigid tube 18 with associated inner portion and one or more position indicators 19. The tube 18 can, by means of optical navigation technique, be inserted towards the object 5 to be treated. The inner portion of the tube 18 is then replaced by the therapeutic ultrasound transducer 2 and said tube 18 is schematically illustrated in FIG. 1 with broken lines.

The therapeutic ultrasound transducer 2 can be arranged to be positioned manually or be arranged at a positioning device 40 for positioning the same relative to the disc 5 to be treated. The treatment device 1 can also comprise an optical navigating device with an X-ray camera (not shown). The positioning and navigation means do not form parts of the present invention.

The therapeutic ultrasound transducer 2 comprises a probe 10, which preferably is an elongated probe 10. The front portion or portions of the probe 10 can be positioned in contact with the disc 5.

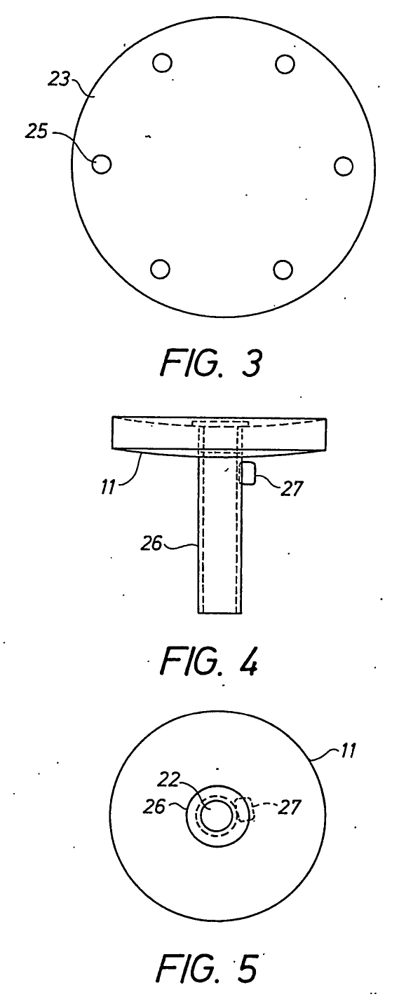

The front portion of the probe 10 is shown in more detail in FIGS. 2 and 3. The probe has a probe body 20 holding the various components, such as a transmitter element 11, e.g. a piezoelectric element, an irrigation conduit 22 and a front cover 23, and a thermistor 27.

The transmitter element 11 is suitably a single piezoelectric element. However, the invention is equally applicable with an array of multiple transmitter elements. As is shown, the transmitter element has a curved front surface in order to focus the transmitted ultrasound field. Also a passive element could be placed in front of the transmitter to achieve the focusing function, which in that case can be either curved or flat The transmitter element 11 is preferably tilted an angle α so that the focus (F in FIG. 1) is displaced from the longitudinal axis of the probe or the design of the passive element is such that said displacement is achieved. This means that when the probe is rotated around its longitudinal axis the focal point F describes a circle around the axis. This results in that the intensity of the ultrasound field is expanded from a volume around the focal point F to a torus-shaped volume. In addition, the probe may also be moved lengthways along the longitudinal axis, resulting in that the maximum ultrasound intensity is expanded over a volume shaped like a spiral or cylinder. The longitudinal movement may be performed simultaneously with the rotation, so that the focal point describes a spiral, or stepwise, so that the focal point describes a number of adjacent parallel circles. A heating effect is achieved in the centre of the torus-shaped or cylindrical volumes as well, due to the volume of the focus and heat conduction. The present invention is also applicable with a probe with no tilt (α=0).

The movement of the probe is achieved by means of a motor operated positioning device 40. The movement could also be achieved manually.

As is most clearly shown in FIG. 5, the transmitter element 11 is provided with an opening 22 in its centre. The directivity and hence the ability of producing a sharp focus is essentially due to the peripheral parts of the transducer. Large coherently emitting surfaces are known to produce interference peaks close to the surface.

FIGS. 6A and 6B are schematic diagrams of ultrasound field intensity versus distance from the transmitter without a centre opening and with a centre opening according to the invention, respectively. As is may be seen in FIG. 6A, a transmitter element without an opening according to the prior art has a wanted maximum M at a distance x located in the object to be treated and an unwanted peak P at a distance y located in the near field. As may be seen, the ultrasound field comprises several narrower peaks P′ but only the peak P is causing a problem. This distance y may be located in the patient's skin and the unwanted peak P can cause pain as mentioned in the introduction.

On the other hand, providing a centre opening in the transmitter element 11 reduces the effect of the unwanted peak P by repositioning the peaks of the ultrasound field as may be seen in FIG. 6B. If the distance Y is located at a sensitive position, the peak P is shifted to a position z where the emitted ultrasound is doing less or no harm. At the position y there is now low ultrasound field intensity. Also the narrower peaks P′ have shifted and changed shape. Since the centre part of the transmitter element also contributes to the wanted peak M, this peak M will also be somewhat shifted and decreased with the transmitter element 11 according to the invention. The loss in surface area is rather small and may be compensated by a slight increase in driving voltage, thus increasing the emitted ultrasound power per surface unit of the transmitter element. This is safe to do, especially in view of the repositioning of the unwanted peak P.

In the simulations of FIGS. 6A and 6B, the transmitter had a radius of curvature of 15 mm and the emitted ultrasound a frequency of 4 MHz. In FIG. 6B, the diameter of the centre opening was 3 mm.

The exact appearance of the ultrasound field intensity depends on the ultrasound wavelength, the acoustic properties of the various tissues involved, the focal distance and diameter of the transmitter system, and the ratio between surface area of the central opening and the exterior diameter. Generally, the appearance of the ultrasound field intensity may be adjusted by changing any one of these factors, but the centre opening has further advantages as discussed below.

The same reduction is achieved with a solid transmitter without an opening but with a central area having no transmitting activity. However, the central opening may be used for inserting instruments, for suction or for irrigation of the transmitter as is described below. The central opening may be formed by one or more separate holes.

The surface area of the central opening is suitably 1-25%, preferably 5-15%, and in a preferred embodiment around 10%, of the total surface area of the transmitter element The diameter of the transmitter element is in the range of 2-100 mm, normally 2-20 mm, and around 5 mm in the case of mini-invasive treatment. The diameter is not critical in the case of non-invasive treatment.

During operation, the transmitter element 11 itself is heated, so that it also generates heat in its vicinity. This heat is generally not desired and should be cooled off. To this end, fluid is brought in front of the transmitter element. The fluid also functions as an acoustic coupler and prevents air pockets from stopping the ultrasound field. Suitably, the transmitter element is provided with a channel in the central opening 22 for letting the fluid through. In principle, fluid may flow freely in front of the transmitter but it is preferred that the tip of the probe is covered by a flexible wall or a perforated cover 23 of suitable material defining a chamber 24 between the transmitter element 11 and the cover 23.

FIG. 3 shows examples of these covers 23. The cover is provided with one or more perforations or holes 25 of suitable size and preferably distributed evenly on the front surface of the cover. In the figure, six holes are shown as an example. The ratio of the surface area of the perforations 25 to the whole area is normally in the range of 0.1-0.9, suitably 0.1-0.7, preferably 0.1-0.5, and in a preferred embodiment 0.1-0.3. The suitable range depends on the viscosity of the fluid, which may be a liquid or gel, and the performed treatment. The perforated cover 23 results in that the fluid is distributed evenly in front of the transmitter element 11 so that heat cannot build up excessively. Instead of placing the cover on the probe it can be placed on the cannula for inserting the probe.

In a preferred embodiment, the probe is further provided with a safety switch that is arranged to switch off the operation of the transmitter element 11 in case there is a problem with the irrigation operation. The safety switch comprises a temperature sensor 27, e.g. a thermistor. Preferably, the thermistor is placed in contact with a metal tube 26 leading the irrigation fluid through the transmitter element. Thus, the thermistor is placed behind the transmitter element 11, not in the fluid but in excellent heat contact with the transmitter element 11 by means of the heat conducting tube 26. The tube is suitably made of metal, preferably silver. In this way the temperature sensor 27 will sense in fractions of a second when there is a problem with the irrigation circuit. The safety switch is arranged to switch of the transmitter element when the sensed temperature deviates from a pre-set value, e.g. more than +10° C. from the pre-set value. With the normally used powers of the transmitter element there is no risk of injuring the patient, since the safety switch acts well in advance.

The described apparatus can be used in methods for treatment of discs but also for treatment of other objects in the body. As examples of such other objects can be mentioned tendons and ligaments in for example shoulders, knees, elbows or feet The scope of the invention is only limited by the claims below.

1. An ultrasound probe comprising a probe body and a transducer means for generating a focussed ultrasound field, the intensity maximum of which is located in an object for heating thereof, wherein the transducer means has a central opening which improves the emitted intensity pattern, and that the central opening is provided with a channel for conducting fluid through the transducer means and that a recess is formed in front of the transducer means.

2. An ultrasound probe according to claim 1, wherein the transducer means has a curved front surface.

3. An ultrasound probe according to claim 1, further comprising a perforated cover forming a chamber in front of the transducer means.

4. An ultrasound probe according to claim 3, wherein the cover is provided with a number of perforations distributed over the front surface.

5. An ultrasound probe according to claim 4, wherein a ratio of the surface area of the perforations to the whole area is in the range of 0.1-0.9.

6. An ultrasound probe according to claim 4, wherein a ratio of the surface area of the perforations to the whole area is in the range of 0.1-0.7.

7. An ultrasound probe according to claim 4, wherein a ratio of the surface area of the perforations to the whole area is in the range of 0.1-0.5.

8. An ultrasound probe according to claim 4, wherein a ratio of the surface area of the perforations to the whole area is in the range of 0.1-0.3.

9. An ultrasound probe according to claim 1, wherein the channel comprises a heat conducting tube, and the probe further comprises a temperature sensor located behind the transducer means and in thermal contact with the tube, wherein the temperature sensor is connected to a control means for interrupting the operation of the transducer means when a sensed temperature deviates from a pre-set value.

10. An ultrasound probe according to claim 9, wherein the control means is adapted to interrupt the operation of the transducer means when the sensed temperature deviates more than +10° C. from the pre-set value.

11. An ultrasound probe according to claim 9, wherein the temperature sensor is a thermistor.

12. An ultrasound probe according to claim 1 or 9, wherein the transducer means is arranged, so that the focus of the ultrasound field is displaced an angle (α) from the longitudinal axis of the probe body.

13. An ultrasound probe according to claim 12, wherein the transducer means is tilted an angle α.

14. An ultrasound probe according to claim 12, wherein the transmitter means comprises a passive element having a design such that said displacement is achieved.

15. An ultrasound probe according to claim 12, wherein the probe body (20) is rotatable around its longitudinal axis.

16. An ultrasound probe according to claim 15, wherein the probe body is displaceable along its longitudinal axis.

17. An ultrasound probe according to claim 1, wherein the surface area of the central opening is suitably 1-25% of the total surface area of the transducer means.

18. An ultrasound probe according to claim 17, wherein the surface area of the central opening is suitably 5-15% of the total surface area of the transducer means.

19. An ultrasound probe according to claim 18, wherein the surface area of the central opening is approximately 10% of the total surface area of the element transducer means.

20. An ultrasound probe according to claim 1 or 9, wherein the total diameter of the transducer means is in the range of 2-100 mm.

21. An ultrasound probe according to claim 20, wherein the total diameter of the transducer means is in the range of 2-20 mm.

22. An ultrasound probe according to claim 1 or 9, wherein the transducer means comprises a single piezoelectric crystal.

23. An ultrasound probe according to claim 1 or 9, wherein the transducer means comprises an array of piezoelectric crystals.

24. Use of an ultrasound probe according to claim 1 or 9, wherein the ultrasound probe is used in methods for treatment of an object in a patient's body, such as for treatment of discs or tendons and ligaments in for example shoulders or elbows.
